(19) United States
(12) Patent Application Publication
(10) Pub. No.: US 2014/0307314 A1
(43) Pub. Date: Oct. 16, 2014

(54) DISPLAY DEVICE

(71) Applicant: SEMICONDUCTOR ENERGY LABORATORY CO., LTD., Atsugi-shi (JP)

(72) Inventors: Yuichi Yanagisawa, Atsugi (JP); Hisao Ikeda, Zama (JP); Takuya Kawata, Atsugi (JP)

(73) Assignee: SEMICONDUCTOR ENERGY LABORATORY CO., LTD., Atsugi-shi (JP)

(21) Appl. No.: 14/247,536

(22) Filed: Apr. 8, 2014

(30) Foreign Application Priority Data
Apr. 12, 2013 (JP) 2013-083571

(51) Int. Cl. G02B 27/22

(52) U.S. Cl. CPC G02B 27/2221
USPC 359/478

(57) ABSTRACT

A display device which can display a two-dimensional image that gives a viewer a strong sense of depth or three dimensions is provided. A display device includes a light-transmitting layer with a viewing surface and a convex surface facing each other, and a display region in which a plurality of display elements for displaying an image toward the viewing surface are provided along the convex surface. In the display device, the refractive index of the light-transmitting layer is higher than the refractive index of the atmosphere, and the viewing surface is a surface intersecting the convex surface at three points, or a distance between a foot N of a perpendicular line drawn from a point M on the convex surface to the surface and an intersection P of the perpendicular line with the viewing surface is largest when the point M is at an outermost point.

### BACKGROUND OF THE INVENTION

1. Field of the Invention

The present invention relates to a display device, an electronic device, or a manufacturing method thereof. The present invention particularly relates to a display device or an electronic device utilizing electroluminescence (hereinafter also referred to as EL) or a manufacturing method thereof.

2. Description of the Related Art

A variety of display devices have come onto the market, ranging from large-size display devices such as television receivers to small-size display devices such as cellular phones. As higher value added products, display devices capable of displaying three-dimensional images have been actively developed to provide more realistic images.

Physiological factors in human perception of objects in three dimensions include binocular parallax, convergence, focus adjustment, motion parallax, image size, spatial layout, contrast, shading, and the like.

For example, a display device that displays a stereoscopic image using binocular disparity is known. Such a display device is configured to display, on one screen, an image to be seen from the position of the left eye of a viewer (an image for left eye) and an image to be seen from the position of the right eye of the viewer (an image for right eye). The viewer sees the image for left eye with the left eye and the image for right eye with the right eye and is thus allowed to see a stereoscopic image.

As one example of display devices using eyeglasses, there is a display device which displays an image for left eye and an image for right eye alternately on a screen in synchronization with a shutter provided in eyeglasses, whereby the left eye of a viewer is allowed to see only the image for left eye and the right eye of the viewer is allowed to see only the image for right eye. Thus, the viewer can see a stereoscopic image.

Further, in a display device using a parallax barrier which allows a viewer to see a stereoscopic image with naked eyes, a screen is divided into a plurality of regions for left eye and a plurality of regions for right eye (e.g., strip-like regions) arranged side by side. A parallax barrier is provided to overlap with the boundaries of the regions. On the divided screen, an image for left eye and an image for right eye are displayed at the same time. With the parallax barrier, the regions for displaying the image for right eye are hidden from the left eye of a viewer and the regions for displaying the image for left eye are hidden from the right eye of the viewer; consequently, the left eye is allowed to see only the image for left eye and the right eye is allowed to see only the image for right eye. Thus, the viewer can see a stereoscopic image.

Note that a display device including a switchable parallax barrier for achieving switching between a two-dimensional image display mode and a stereoscopic image display mode is known (Patent Document 1).

A light-emitting element utilizing EL is known. This light-emitting element is a self-luminous type; therefore, high contrast and high-speed response to an input signal are achieved. Furthermore, a display device to which this light-emitting element is applied and which consumes less power, is manufactured in a simple process, and is easily adapted to the increase in definition and the size of a substrate is known (Patent Document 2).

### REFERENCES

### Patent Documents

[Patent Document 1] PCT International Publication No. WO2004/003630

### [Patent Document 2] Japanese Published Patent Application No. 2011-238908

### SUMMARY OF THE INVENTION

A display device utilizing eyeglasses with shutters displays images for left eye and images for right eye alternately on a screen, which results in an increase in the frequency of image writing to a pixel portion in one frame period as compared with the case of displaying a two-dimensional image. This requires a driver circuit which can be driven at high frequency and also increases the power consumption of the display device.

In a display device with a parallax barrier, the number of pixels that contribute to image display for left eye and the number of pixels that contribute to image display for right eye in the horizontal direction of a pixel portion are reduced to half of the actual number, which prevents high-definition images from being displayed.

Accordingly, it is demanded that a display device can display a two-dimensional image that gives a viewer a strong sense of depth or three dimensions instead of images with binocular disparity such as images for left eye and images for right eye.

It is an object of one embodiment of the present invention to provide a display device which can display a two-dimensional image that gives a viewer a strong sense of depth or three dimensions. It is another object of one embodiment of the present invention to provide an electronic device which can display a two-dimensional image that gives a viewer a strong sense of depth or three dimensions.

One embodiment of the present invention is a display device which includes a light-transmitting layer with a viewing surface and a convex surface facing each other, and a display region in which a plurality of display elements for displaying an image toward the viewing surface are provided along the convex surface. The refractive index of the light-transmitting layer is higher than the refractive index of the atmosphere. The viewing surface is a surface that intersects the convex surface at at least three points.

One embodiment of the present invention is a display device which includes a light-transmitting layer with a viewing surface and a convex surface facing each other, and a display region in which a plurality of display elements for displaying an image toward the viewing surface are provided along the convex surface. The refractive index of the light-transmitting layer is higher than the refractive index of the atmosphere. The viewing surface is a surface that intersects the display region at at least three points.

One embodiment of the present invention is a display device which includes a light-transmitting layer with a viewing surface and a convex surface facing each other, and a display region in which a plurality of display elements for displaying an image toward the viewing surface are provided along the convex surface. The refractive index of the light-transmitting layer is higher than the refractive index of the atmosphere. A distance between a foot N of a perpendicular line drawn from a point Mon the convex surface to a surface intersecting the convex surface at at least three points and an intersection P of the perpendicular line with the viewing surface is largest when the point M is at an outermost point.

One embodiment of the present invention is a display device which includes a light-transmitting layer with a viewing surface and a convex surface facing each other, and a display region in which a plurality of display elements for displaying an image toward the viewing surface are provided along the convex surface. The refractive index of the light-transmitting layer is higher than the refractive index of the atmosphere. A distance between a foot N of a perpendicular line drawn from a point Mon the convex surface to a surface intersecting the display region at at least three points and an intersection P of the perpendicular line with the viewing surface is largest when the point M is at an outermost point.

In the display device of any of the above embodiments, when a viewer sees a display surface from a viewing surface side, a virtual image is formed neither on the viewing surface of the display device nor on the display surface of the display region because the refractive index of the light-transmitting layer is higher than the refractive index of the atmosphere; this causes a misinterpretation by viewer's brain and gives an increased sense of depth or three dimensions to an image. In addition, since the display elements are provided along the convex surface, the position of a virtual image formed in the display device in the thickness direction differs between an edge portion and a central portion of the viewing surface of the display device. This gives a further increased sense of depth or three dimensions to an image.

Note that the term “outermost point” in this specification refers to a point on the convex surface that is the farthest from the viewing surface. There may be only one outermost point or a plurality of outermost points in the display device. In the case where there are a plurality of outermost points, any one of the points can be selected as appropriate. Assuming that there are a plane a and a point h not on the plane a and that a point k is an intersection of the plane a with a straight line n passing through the point h and being perpendicular to the plane a, in this specification, the straight line n is referred to as a perpendicular line drawn from the point h to the plane a, and the point k is referred to as the foot of the perpendicular line.

In each of the above embodiments, the display region includes a first display element, and Y/X is preferably greater than or equal to 0.1 and less than or equal to 1, more preferably greater than or equal to 0.15 and less than or equal to 0.6, further preferably greater than or equal to 0.2 and less than or equal to 0.4, where X is a distance between the first display element and an intersection Q of a perpendicular line drawn to an outermost point on the convex surface with a plane intersecting the perpendicular line orthogonally and passing through the first display element, and Y is a distance between the intersection Q and the outermost point.

In each of the above embodiments, it is preferable that the display device further include a light-transmitting substrate over the viewing surface.

In each of the above embodiments, it is preferable that the refractive index of the light-transmitting layer be higher than or equal to 1.6.

According to one embodiment of the present invention, a display device which can display a two-dimensional image that gives a viewer a sense of depth or three dimensions can be provided. According to one embodiment of the present invention, an electronic device which can display a two-dimensional image that gives a viewer a sense of depth or three dimensions can be provided.

### BRIEF DESCRIPTION OF THE DRAWINGS

FIGS. 1A to 1C illustrate a display device.

FIGS. 2A to 2C illustrate display devices.

FIGS. 3A to 3D illustrate display devices.

FIGS. 4A to 4C each illustrate a display unit included in a display region.

FIGS. 5A to 5E illustrate electronic devices.

### DETAILED DESCRIPTION OF THE INVENTION

Embodiments will be described in detail with reference to the drawings. Note that the present invention is not limited to the following description, and it will be easily understood by those skilled in the art that various changes and modifications can be made without departing from the spirit and scope of the present invention. Therefore, the present invention should not be construed as being limited to the description in the following embodiments.

Note that in the structures of the invention described below, the same portions or portions having similar functions are denoted by the same reference numerals in different drawings, and description of such portions is not repeated. Further, the same hatch pattern is applied to similar functions, and these are not especially denoted by reference numerals in some cases.

In addition, the position, size, range, or the like of each structure illustrated in drawings and the like is not accurately represented in some cases for easy understanding. Therefore, the disclosed invention is not necessarily limited to the position, size, range, or the like disclosed in the drawings and the like.

### <Structure of a Display Device in One Embodiment of the Present Invention>

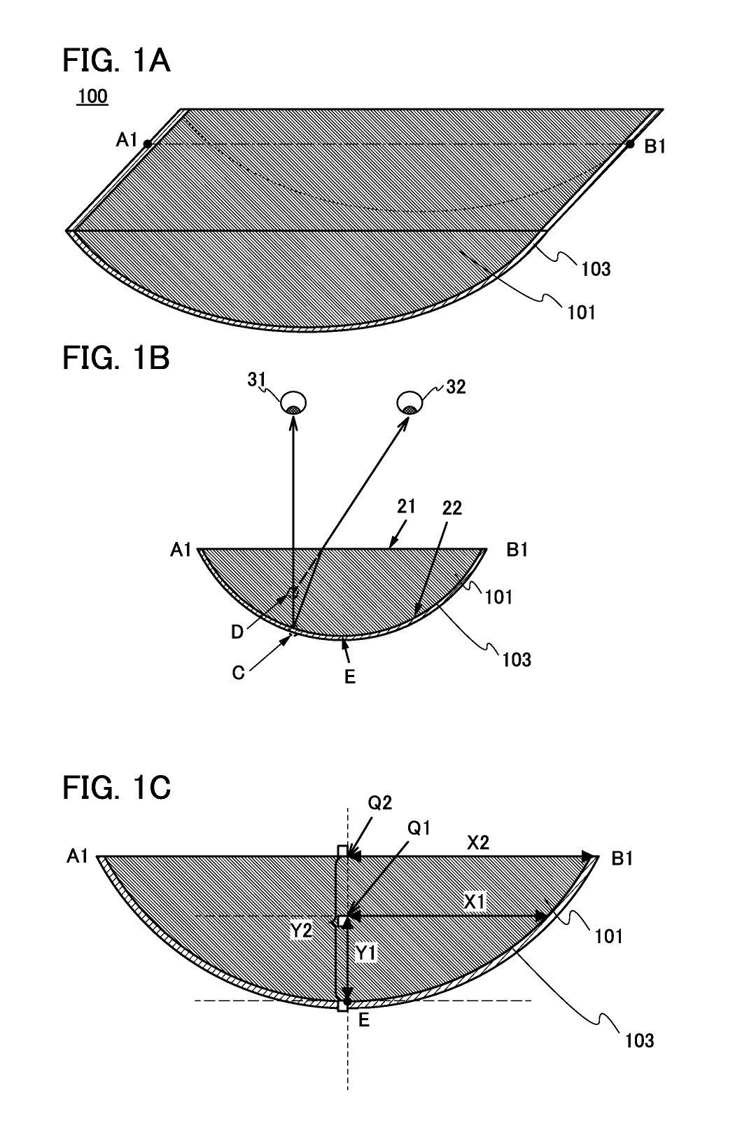

Display devices according to embodiments of the present invention will be described with reference to FIGS. 1A to 1C, FIGS. 2A to 2C, FIGS. 3A to 3D, and FIGS. 4A to 4C.

A display device according to one embodiment of the present invention includes a light-transmitting layer and a display region. The light-transmitting layer has a convex surface and a viewing surface facing the convex surface. In the display region, a plurality of display elements capable of displaying an image toward the viewing surface are provided along the convex surface. A display surface of the display region is in contact with the convex surface of the light-transmitting layer in the display device according to one embodiment of the present invention. As an example of a shape of the light-transmitting layer, a column with a bottom surface whose boundary consists of a curved line (a cylinder with a perfect circle-shaped bottom surface, an elliptic cylinder with an ellipse-shaped bottom surface, or the like), or a column with a bottom surface whose boundary consists of a curved line and a straight line (a column with a semi cylindrical-shaped bottom surface, a semi elliptical cylindrical-shaped bottom surface, or the like) can be given. If a shape of the light-transmitting layer is any of such columns, the convex surface corresponds to a curved surface of the column, and the viewing surface corresponds to a surface opposite to the curved surface of the column.

The viewing surface may be a flat surface or a curved surface (a concave surface or a convex surface) or may partly have a curved surface (a convex portion or a concave portion).

FIG. 1A shows a perspective view of a display device 100, and FIGS. 1B and 1C show cross-sectional views taken along dashed-dotted line A1-B1 in FIG. 1A. The display device 100 illustrated in FIGS. 1A to 1C includes a light-transmitting layer 101 and a display region 103.

In the display device 100, a viewing surface 21 of the light-transmitting layer 101 is a flat surface. Specifically, the viewing surface 21 is a plane that intersects the display region 103 at at least three points. Furthermore, the viewing surface 21 is a plane that intersects the convex surface 22 at at least three points.

Light delivered from a point C on the display surface of the display region 103 to viewer's eye 31 enters the interface between the light-transmitting layer 101 and the atmosphere perpendicularly and therefore travels straight. In contrast, light delivered from the point C to viewer's eye 32 enters the interface between the light-transmitting layer 101 and the atmosphere at an angle and therefore refracts at the interface. This refraction of light causes a virtual image to be formed at a position D that is neither on the display surface of the display region 103 (here, a surface in contact with the convex surface 22) nor on a viewing surface of the display device 100 (here corresponding to the viewing surface 21 of the light-transmitting layer 101). The viewer sees this virtual image; thus, the display device 100 gives a sense of depth or three dimensions to an image.

In the display region 103, a plurality of display elements capable of displaying an image toward the viewing surface 21 are provided along the convex surface 22. Therefore, the position of a virtual image formed in the display device 100 in the thickness direction differs between an edge portion and a central portion of the viewing surface of the display device. This gives an increased sense of depth or three dimensions to an image.

In the display device 100, the display region 103 preferably includes a first display element which satisfies the following conditions. Specifically, Y/X is greater than or equal to 0.1 and less than or equal to 1, preferably greater than or equal to 0.15 and less than or equal to 0.6, more preferably greater than or equal to 0.2 and less than or equal to 0.4, where X is a distance between the first display element and an intersection Q of a perpendicular line drawn to an outermost point E on the convex surface 22 with a plane intersecting the perpendicular line orthogonally and passing through the first display element, and Y is a distance between the intersection Q and the outermost point E.

In the display device including the first display element, a larger difference in the position of a virtual image formed in the display device 100 in the thickness direction is made between the edge portion and the central portion of the viewing surface of the display device. Thus, the display device including the first display element is preferable because it is effective in increasing the sense of depth or three dimensions in an image.

In one example of a structure, as illustrated in FIG. 1C, Y1/X1 is greater than or equal to 0.1 and less than or equal to 1, preferably greater than or equal to 0.15 and less than or equal to 0.6, more preferably greater than or equal to 0.2 and less than or equal to 0.4, where X1 is a distance between a given display element and an intersection Q1 of a perpendicular line drawn to an outermost point E on the convex surface 22 with a plane intersecting the perpendicular line orthogonally and passing through the display element, and Y1 is a distance between the intersection Q1 and the outermost point E. The display element may be located in an edge portion of the display region 103. In another example of a structure, as illustrated in FIG. 1C, Y2/X2 is greater than or equal to 0.1 and less than or equal to 1, preferably greater than or equal to 0.15 and less than or equal to 0.6, more preferably greater than or equal to 0.2 and less than or equal to 0.4, where X2 is a distance between a display element located in the edge portion of the display region 103 and an intersection Q2 of a perpendicular line drawn to an outermost point E on the convex surface 22 with a plane intersecting the perpendicular line orthogonally and passing through the display element, and Y2 is a distance between the intersection Q2 and the outermost point E.

It is preferable that the display device do not include a display element that makes the above value of Y/X greater than 1. If a display element of the display device makes the value of Y/X greater than 1, the thickness of the display device increases, which makes it difficult to reduce the thickness of the display device or an electronic device including the display device. In addition, the durability of the display element (a display unit or a display region including the display element) might be lowered.

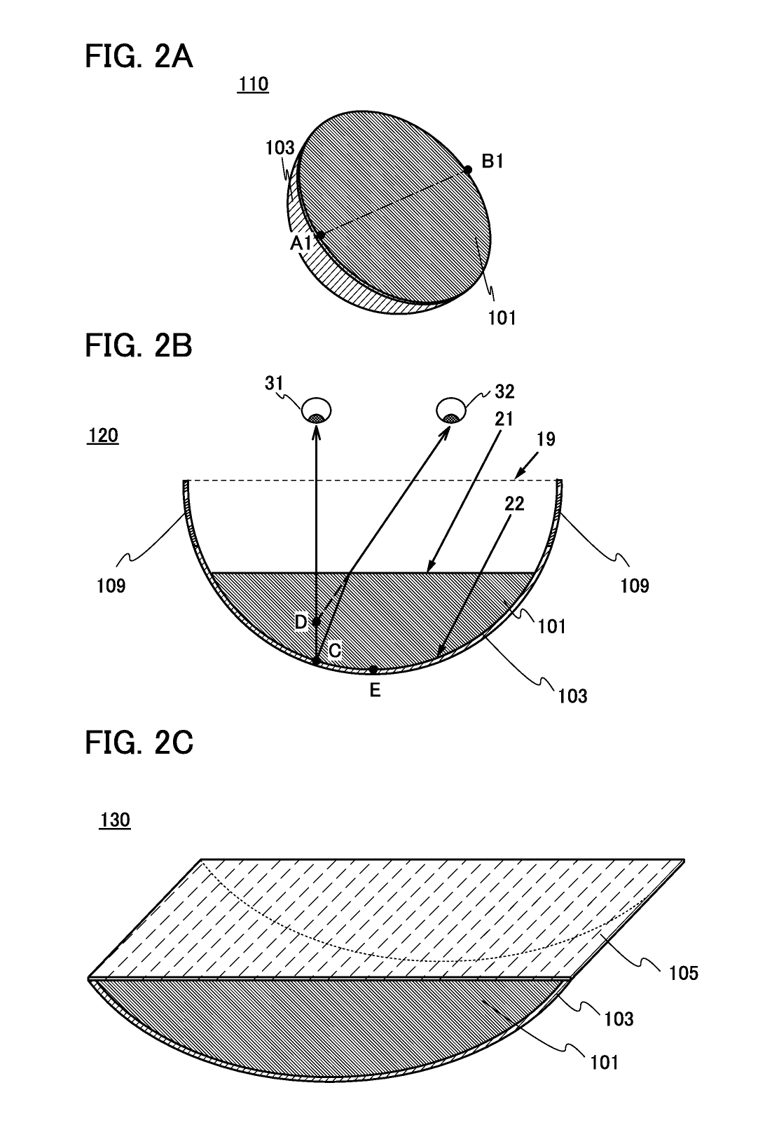

Although the viewing surface of the display device 100 is quadrangular, the viewing surface may be in the shape of a polygon, a circle, an ellipse, or the like and is not particularly limited. For example, the viewing surface may be circular as in a display device 110 illustrated in FIG. 2A. FIGS. 1B and 1C can be referred to for a cross-sectional view of the display device 110 along dashed-dotted line A1-B1.

In the display device, it is preferable that at least part of the display surface of the display region 103 be in contact with the convex surface of the light-transmitting layer 101. For example, as in the display device 110 or the like, the whole display surface of the display region 103 may be in contact with the convex surface of the light-transmitting layer 101. As another example, a display device 120 is illustrated in FIG. 2B. The display device 120 includes a display panel in which the display region 103 is provided between a pair of driver circuit regions 109, and part of the display surface of the display region 103 is not in contact with the light-transmitting layer 101. Note that the present invention is not limited as long as the viewing surface of the light-transmitting layer 101 is a surface that intersects the convex surface of the light-transmitting layer 101 at at least three points (i.e., does not necessarily intersect the display region 103 at three points). For example, the viewing surface of the light-transmitting layer 101 may be a plane 19 that intersects the pair of driver circuit regions 109 at at least three points as illustrated in FIG. 2B. Furthermore, the viewing surface is not necessarily a flat surface.

As in a display device 130 illustrated in FIG. 2C, a light-transmitting substrate 105 may be provided over the viewing surface of the light-transmitting layer 101 (or may be provided in contact with the viewing surface 21). Instead of the light-transmitting substrate 105 or as a layer of the light-transmitting substrate 105, a hard coat film, an anti-reflection film, a touch panel, or the like may be provided. The hard coat film has a hardness higher than that of at least the light-transmitting layer 101, and an inorganic insulating film such as a silicon nitride film can be used, for example. As the anti-reflection film, a film having surface irregularities at a regular pitch of approximately several hundred nanometers, such as a moth-eye structure, can be used, for example. As the touch panel, any of various types such as a capacitive type, a resistive type, a surface acoustic wave type, an infrared ray type, and an optical type can be used.

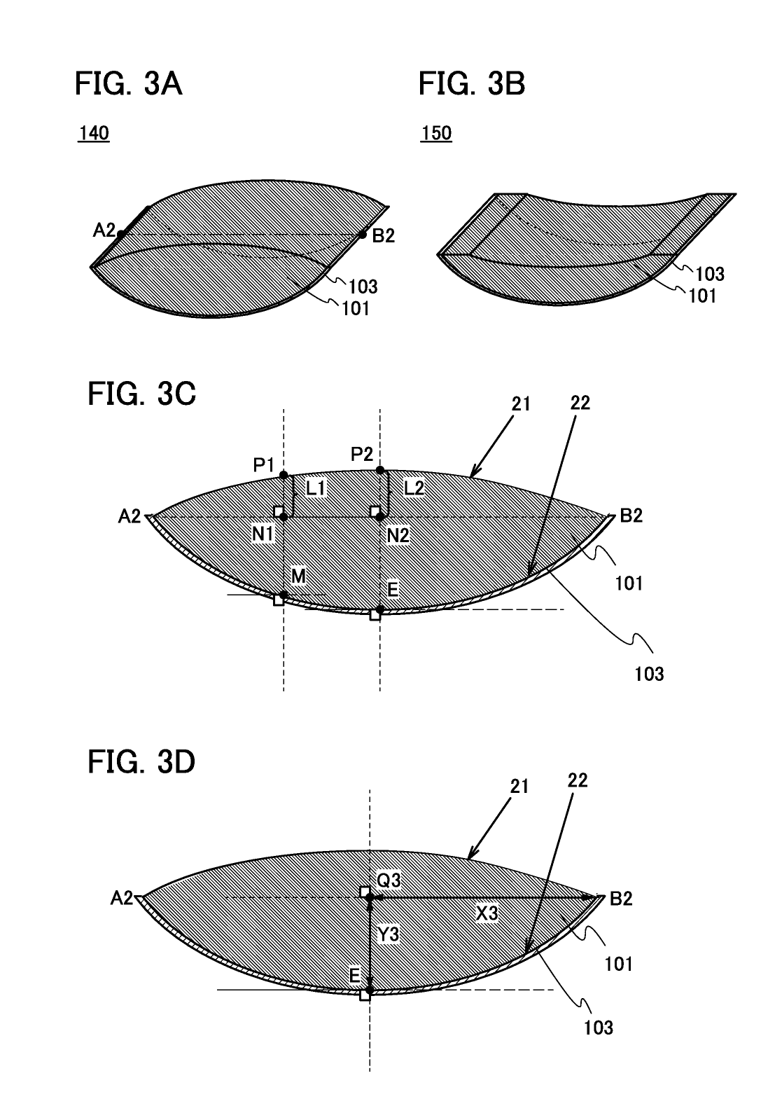

FIG. 3A shows a perspective view of a display device 140. FIG. 3B shows a perspective view of a display device 150. FIGS. 3C and 3D show cross-sectional views taken along dashed-dotted line A2-B2 in FIG. 3A. The display device 140 and the display device 150 each include the light-transmitting layer 101 and the display region 103.

In the display device 140, the viewing surface 21 of the light-transmitting layer 101 is a curved surface. In the display device 150, part of the viewing surface 21 of the light-transmitting layer 101 is a curved surface.

Specifically, the viewing surface 21 of the display device 140 or 150 satisfies the following conditions. That is, a distance between a point N and a point P where the point N is a foot of a perpendicular line drawn from a point Mon the convex surface 22 to a surface intersecting a boundary line between the convex surface 22 and the viewing surface 21, and the point P is an intersection of the perpendicular line with the viewing surface 21 is largest when the point M is at the outermost point E. FIG. 3C illustrates an example in which a distance L2 between a foot N2 of a perpendicular line drawn from an outermost point E and an intersection P2 of the perpendicular line with the viewing surface 21 is larger than a distance L1 between a foot N1 of a perpendicular line drawn from a point M1 on the convex surface 22 and an intersection P1 of the perpendicular line with the viewing surface 21.

Also in a display device having such a structure, a virtual image can be formed at a position that is neither on a display surface of the display region 103 nor on a viewing surface of the display device. A viewer sees this virtual image; thus, the display device gives a sense of depth or three dimensions to an image.

In the display region 103, a plurality of display elements capable of displaying an image toward the viewing surface 21 are provided along the convex surface 22. Therefore, the position of a virtual image formed in the display device in the thickness direction differs between an edge portion and a central portion of the viewing surface of the display device. This gives an increased sense of depth or three dimensions to an image.

In the display device 140 or 150, the display region 103 preferably includes a first display element which satisfies the conditions given above.

In one example of a structure, as illustrated in FIG. 3D, Y3/X3 is greater than or equal to 0.1 and less than or equal to 1, preferably greater than or equal to 0.15 and less than or equal to 0.6, more preferably greater than or equal to 0.2 and less than or equal to 0.4, where X3 is a distance between a given display element and an intersection Q3 of a perpendicular line drawn to an outermost point E on the convex surface 22 with a plane intersecting the perpendicular line orthogonally and passing through the display element, and Y3 is a distance between the intersection Q3 and the outermost point E.

<Materials that can be Used for the Display Device According to One Embodiment of the Present Invention>

Next, examples of materials that can be used for the display device according to one embodiment of the present invention are described.

### [Light-Transmitting Layer]

The light-transmitting layer is formed using a material having a light-transmitting property and having a refractive index higher than that of the atmosphere. For example, an organic resin such as a resin which is curable at room temperature (e.g., a two-component type resin), a light-curable resin, or a heat-curable resin can be used.

For example, an organic resin such as a polyvinyl chloride (PVC) resin, an acrylic resin, a polyimide resin, an epoxy resin, a silicone resin, a polyvinyl butyral (PVB) resin, or an ethylene vinyl acetate (EVA) resin can be used. Further, a drying agent may be contained in the organic resin.

For the light-transmitting layer, a material having a light-transmitting property and a high refractive index is preferably used. For example, a material having a refractive index higher than or equal to 1.6, preferably higher than or equal to 1.7, and less than or equal to 2.1 is used. Examples of the material having a high refractive index include a resin containing bromine, a resin containing sulfur, and the like. For example, a sulfur-containing polyimide resin, an episulfide resin, a thiourethane resin, a brominated aromatic resin, or the like can be used. Polyethylene terephthalate (PET), triacetyl cellulose (TAC), or the like can also be used.

Note that the state of the light-transmitting layer is not particularly limited and may be solid (including a gel or the like) or liquid (including a sol or the like).

Note that the light-transmitting layer may be detachable in the display device according to one embodiment of the present invention. In the case where the display region is flexible, the display region can be shaped to fit the light-transmitting layer used. Thus, by selecting and using one of a plurality of light-transmitting layers having different shapes, for example, the degree of the sense of depth or three dimensions provided by one display device can be adjusted for every use.

### [Display Region]

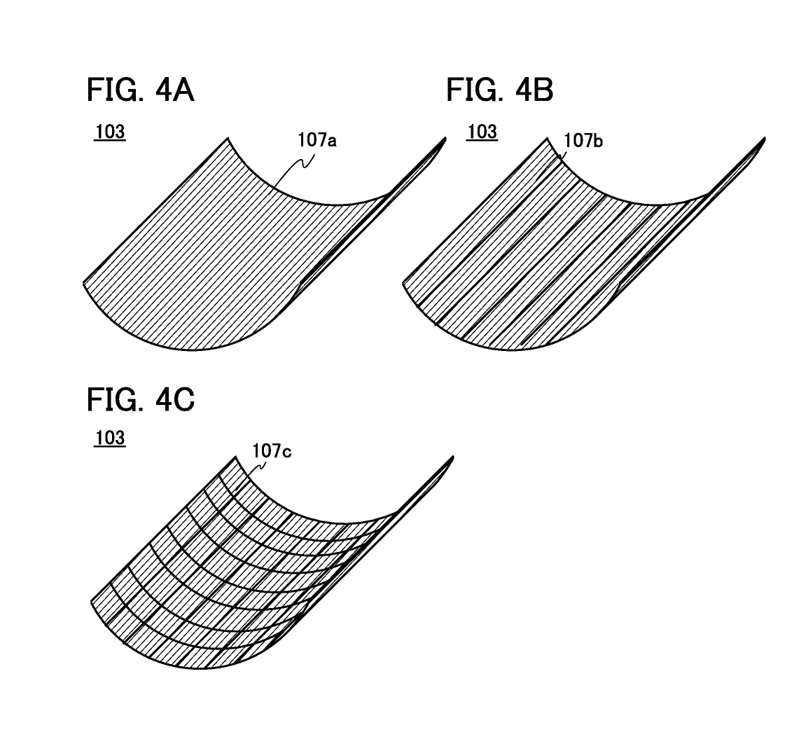

The display region includes one or more display units. In the case where one display unit 107a constitutes the display region as illustrated in FIG. 4A, a flexible display unit can be used as the display unit 107a. Alternatively, a display unit which is not flexible and is shaped so as to have a concave display surface can be used as the display unit 107a.

In the case where two or more display units constitute the display region as illustrated in FIG. 4B or 4C, a plurality of display units 107b or a plurality of display units 107c may be provided over a concavely curved surface of a support. Note that the support may be flexible or not. As the display units 107b or 107c, flexible display units can be used. Alternatively, display units which are not flexible and are curved along a surface of the support over which the display units are provided can be used as the display units 107b or 107c. Still alternatively, display units which are not flexible or curved (i.e., which have flat display surfaces) can be used as the display units 107b or 107c. In the case where the plurality of display units 107b are provided side by side or the plurality of display units 107c are provided in a matrix, a curved display region can be obtained even when the display units are not flexible and have flat display surfaces.

In the display unit, a material having a light-transmitting property is used for at least one of substrates. There is no particular limitation on the display element, for which a liquid crystal element, a light-emitting element (such as a light-emitting diode, an organic EL element, or an inorganic EL element), a plasma tube, a cathode ray tube (CRT), or the like can be used.

The organic EL element is preferably used as the display element because the display unit can be flexible, the display unit can be lightweight, and no backlight is needed, for example.

The display region may be an active matrix type or a passive matrix type.

In the case where the display region is an active matrix type, the structure of a transistor included in the display unit is not limited, and either a top-gate transistor or a bottom-gate transistor may be used. In addition, either an n-channel transistor or a p-channel transistor may be used. Furthermore, there is no particular limitation on a material used for the transistor. For example, a transistor in which silicon or an oxide semiconductor such as an In—Ga—Zn-based metal oxide is used in a channel formation region can be employed.

### [Light-Transmitting Substrate]

The light-transmitting substrate is formed using a light-transmitting material. For example, a material such as glass, quartz, ceramics, sapphire, or an organic resin can be used.

For example, glass such as alkali-free glass, barium borosilicate glass, or aluminoborosilicate glass can be used. Glass that is thin enough to have flexibility may be used.

For example, an organic resin can be used, examples of which include a polyester resin such as polyethylene terephthalate (PET) or polyethylene naphthalate (PEN), a polyacrylonitrile resin, a polyimide resin, a polymethylmethacrylate resin, a polycarbonate (PC) resin, a polyethersulfone (PES) resin, a polyamide resin, a cycloolefin resin, a polystyrene resin, a polyamide imide resin, a polyvinyl chloride resin, and the like. In particular, a material whose thermal expansion coefficient is low is preferable, and for example, a polyamide imide resin, a polyimide resin, PET, or the like can be suitably used. A substrate in which a glass fiber is impregnated with an organic resin or a substrate whose thermal expansion coefficient is reduced by mixing an organic resin with an inorganic filler can also be used. A substrate using such a material is lightweight, and thus a display device using this substrate can also be lightweight.

### <Method for Manufacturing the Display Device According to One Embodiment of the Present Invention>

Next, an example of a method for manufacturing the display device according to one embodiment of the present invention is described.

For example, a display region having a concave display surface is formed using one or more of the above-described display units. Then, the concave portion of the display region is filled with a light-transmitting material. After that, the light-transmitting material is cured, whereby a light-transmitting layer is formed. Note that in the case where a light-transmitting substrate or the like is provided over a viewing surface of the light-transmitting layer, the light-transmitting layer may be cured after the light-transmitting substrate or the like is placed over the light-transmitting layer.

A mold or a support may be used to form the light-transmitting layer in a desired shape. The light-transmitting layer and the display region may be bonded to each other or may be detachable from each other. It is preferable that there be no gap between the light-transmitting layer and the display region. Thus, it is preferable that the adhesion between the light-transmitting layer and the display region be high.

A display panel can be manufactured using a variety of manufacturing methods. For example, a display panel having a curved display surface may be manufactured by forming a display element over a curved support. Alternatively, after a flexible display panel is manufactured, the display panel may be curved. In the case where a display panel including two or more display units is manufactured, a curved support may be covered with a plurality of display units.

As methods for forming an element (at least one of a display element, a transistor, a color filter, and the like) over a flexible substrate in the case of manufacturing a flexible display panel, there are methods such as a first method in which the element is directly formed over a flexible substrate, and a second method in which the element is formed over a highly heat-resistant substrate (hereinafter referred to as a formation substrate) which is different from a flexible substrate and the element is then separated from the formation substrate and transferred to the flexible substrate.

In the case of using a substrate resistant to heat applied in the process of forming the element, such as a glass substrate thin enough to have flexibility, the first method is preferably used because the process can be simplified.

When the second method is used, an insulating film with low water permeability, a transistor with high reliability, or the like which is formed over a formation substrate can be transferred to a flexible substrate. Therefore, even when an organic resin with high water permeability and low heat resistance or the like is used as a material of the flexible substrate, a flexible display panel with high reliability can be manufactured.

### <Electronic Devices Using the Display Device According to One Embodiment of the Present Invention>

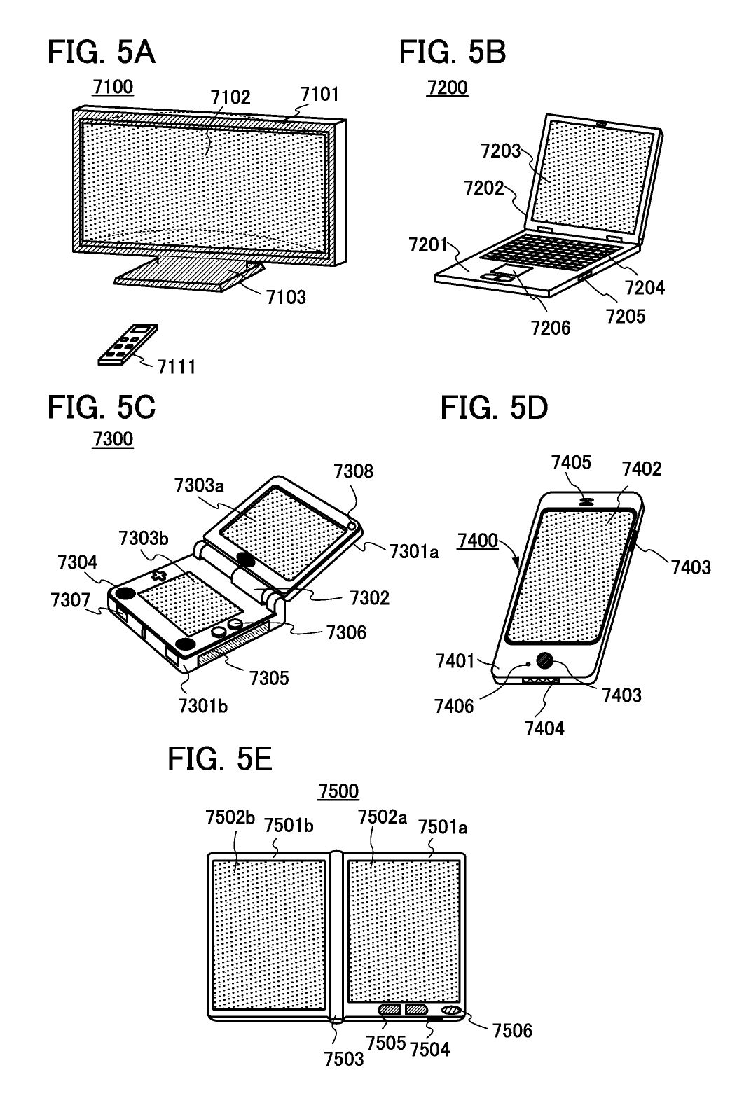

Next, electronic devices including the display device are described with reference to FIGS. 5A to 5E. A display portion of an electronic device according to one embodiment of the present invention can display an image that gives a viewer a strong sense of depth or three dimensions.

Examples of electronic devices are television devices (also referred to as TV or television receivers), monitors for computers and the like, cameras such as digital cameras and digital video cameras, digital photo frames, cellular phones (also referred to as portable telephone devices), portable game machines, portable information terminals, audio playback devices, large game machines such as pin-ball machines, and the like. Specific examples of these electronic devices are illustrated in FIGS. 5A to 5E.

FIG. 5A illustrates an example of a television device. In a television device 7100, a display portion 7102 is incorporated in a housing 7101. The display portion 7102 is capable of displaying images. The display device according to one embodiment of the present invention can be used for the display portion 7102. In addition, here, the housing 7101 is supported by a stand 7103.

The television device 7100 can be operated with an operation switch provided in the housing 7101 or with a separate remote controller 7111. With operation keys of the remote controller 7111, channels and volume can be controlled and images displayed on the display portion 7102 can be controlled. The remote controller 7111 may be provided with a display portion for displaying data output from the remote controller 7111.

Note that the television device 7100 is provided with a receiver, a modem, and the like. With the use of the receiver, general television broadcasting can be received. Moreover, when the television device is connected to a communication network with or without wires via the modem, one-way (from a sender to a receiver) or two-way (between a sender and a receiver or between receivers) information communication can be performed.

FIG. 5B illustrates an example of a computer. A computer 7200 includes a main body 7201, a housing 7202, a display portion 7203, a keyboard 7204, an external connection port 7205, a pointing device 7206, and the like. Note that this computer is manufactured by using the display device of one embodiment of the present invention for the display portion 7203.

FIG. 5C illustrates an example of a portable game machine. A portable game machine 7300 has two housings, a housing 7301a and a housing 7301b, which are connected with a joint portion 7302 so that the portable game machine can be opened or closed. The housing 7301a incorporates a display portion 7303a, and the housing 7301b incorporates a display portion 7303b. In addition, the portable game machine illustrated in FIG. 5C includes a speaker portion 7304, a recording medium insertion portion 7305, an operation key 7306, a connection terminal 7307, a sensor 7308 (a sensor having a function of measuring or sensing force, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays), an LED lamp, a microphone, and the like. It is needless to say that the structure of the portable game machine is not limited to the above structure as long as the display device of one embodiment of the present invention is used for at least either the display portion 7303a or the display portion 7303b, or both, and may include other accessories as appropriate. The portable game machine illustrated in FIG. 5C has a function of reading out a program or data stored in a recoding medium to display it on the display portion, and a function of sharing information with another portable game machine by wireless communication. Note that functions of the portable game machine illustrated in FIG. 5C are not limited to them, and the portable game machine can have various functions.

FIG. 5D illustrates an example of a cellular phone. A cellular phone 7400 is provided with a display portion 7402 incorporated in a housing 7401, an operation button 7403, an external connection port 7404, a speaker 7405, a microphone 7406, and the like. Note that the cellular phone 7400 is manufactured by using the display device of one embodiment of the present invention for the display portion 7402.

When the display portion 7402 of the cellular phone 7400 illustrated in FIG. 5D is touched with a finger or the like, data can be input into the cellular phone. Further, operations such as making a call and creating an e-mail can be performed by touching the display portion 7402 with a finger or the like.

There are mainly three screen modes of the display portion 7402. The first mode is a display mode mainly for displaying an image. The second mode is an input mode mainly for inputting information such as characters. The third mode is a display-and-input mode in which two modes of the display mode and the input mode are combined.

For example, in the case of making a call or creating an e-mail, an input mode mainly for inputting characters is selected for the display portion 7402 so that characters displayed on the screen can be input.

When a sensing device including a sensor such as a gyroscope sensor or an acceleration sensor for detecting inclination is provided inside the cellular phone 7400, display on the screen of the display portion 7402 can be automatically changed in direction by determining the orientation of the cellular phone 7400 (whether the cellular phone 7400 is placed horizontally or vertically for a landscape mode or a portrait mode).

The screen modes are changed by touch on the display portion 7402 or operation with the operation button 7403 of the housing 7401. The screen modes can be switched depending on the kind of images displayed on the display portion 7402. For example, when a signal of an image displayed on the display portion is a signal of moving image data, the screen mode is switched to the display mode. When the signal is a signal of text data, the screen mode is switched to the input mode.

Moreover, in the input mode, if a signal detected by an optical sensor in the display portion 7402 is detected and the input by touch on the display portion 7402 is not performed for a certain period, the screen mode may be controlled so as to be changed from the input mode to the display mode.

The display portion 7402 may function as an image sensor. For example, an image of a palm print, a fingerprint, or the like is taken by the display portion 7402 while in touch with the palm or the finger, whereby personal authentication can be performed. Further, when a backlight or a sensing light source which emits near-infrared light is provided in the display portion, an image of a finger vein, a palm vein, or the like can be taken.

FIG. 5E illustrates an example of a foldable tablet terminal (in an open state). A tablet terminal 7500 includes a housing 7501a, a housing 7501b, a display portion 7502a, and a display portion 7502b. The housing 7501a and the housing 7501b are connected by a hinge 7503 and can be opened and closed using the hinge 7503 as an axis. The housing 7501a includes a power switch 7504, operation keys 7505, a speaker 7506, and the like. Note that the tablet terminal 7500 is manufactured by using the display device of one embodiment of the present invention for either the display portion 7502a or the display portion 7502b, or both.

Part of the display portion 7502a or the display portion 7502b can be used as a touch panel region, where data can be input by touching displayed operation keys. For example, a keyboard can be displayed on the entire region of the display portion 7502a so that the display portion 7502a is used as a touch screen, and the display portion 7502b can be used as a display screen.

This application is based on Japanese Patent Application serial no. 2013-083571 filed with Japan Patent Office on Apr. 12, 2013, the entire contents of which are hereby incorporated by reference.

What is claimed is:

1. A display device comprising:
a light-transmitting layer comprising a viewing surface and a convex surface facing each other; and
a display region comprising a display element for displaying an image toward the viewing surface, the display element being provided along the convex surface,
wherein the viewing surface is in contact with the convex surface at at least three points.

2. The display device according to claim 1, wherein the viewing surface is a flat surface.

3. The display device according to claim 1,
wherein Y/X is greater than or equal to 0.1 and less than or equal to 1,
wherein Y is a distance between an outermost point of the convex surface and a point Q that is arbitrarily located on a line which is perpendicular to the viewing surface and passes the outermost point of the convex surface, and
wherein X is a distance between the point Q and an intersection of the convex surface with a line that is parallel to the viewing surface and passes the point Q.

4. The display device according to claim 1, further comprising a light-transmitting substrate over the viewing surface.

5. The display device according to claim 1, wherein a refractive index of the light-transmitting layer is higher than 1.0.

6. The display device according to claim 1, wherein a refractive index of the light-transmitting layer is higher than or equal to 1.6.

7. The display device according to claim 1, wherein the display element is any one of a liquid crystal element, a light-emitting diode, an organic EL element, an inorganic EL element, a plasma tube, and a cathode ray tube.

8. An electronic device comprising the display device according to claim 1.

9. A display device comprising:
a light-transmitting layer comprising a viewing surface and a convex surface facing each other; and
a display region comprising a display element for displaying an image toward the viewing surface, the display element being provided along the convex surface,
wherein a distance between a point N and a point P is largest when a point M is located at a point of the convex surface,
wherein the point N is a foot of a line which passes the point M that is arbitrarily located on the convex surface and which is perpendicular to a surface intersecting a boundary line between the convex surface and the viewing surface, and
wherein the point P is an intersection of the line with the viewing surface.

10. The display device according to claim 9,
wherein Y/X is greater than or equal to 0.1 and less than or equal to 1,
wherein Y is a distance between an outermost point of the convex surface and a point Q that is arbitrarily located on a line which is perpendicular to the surface and passes the outermost point of the convex surface, and
wherein X is a distance between the point Q and an intersection of the convex surface with a line that is parallel to the surface and passes the point Q.

11. The display device according to claim 9, further comprising a light-transmitting substrate over the viewing surface.

12. The display device according to claim 9, wherein a refractive index of the light-transmitting layer is higher than 1.0.

13. The display device according to claim 9, wherein a refractive index of the light-transmitting layer is higher than or equal to 1.6.

14. The display device according to claim 9, wherein the display element is any one of a liquid crystal element, a light-emitting diode, an organic EL element, an inorganic EL element, a plasma tube, and a cathode ray tube.

15. An electronic device comprising the display device according to claim 9.

16. A display device comprising:
a semi cylindrical light-transmitting member comprising a bottom surface and a curved surface; and
a display element for displaying an image toward the bottom surface, the display element being located along the curved surface.

17. A display device comprising:
a semi elliptical cylindrical light-transmitting member comprising a bottom surface and a curved surface; and
a display element for displaying an image toward the bottom surface, the display element being located along the curved surface.
